(19) United States
(12) Patent Application Publication
(10) Pub. No.: US 2024/0069910 A1
(43) Pub. Date: Feb. 29, 2024

(54) METHOD AND DEVICE FOR EVALUATING WORKLOAD OF PROGRAMMERS

(71) Applicant: MERICO, INC., Palo Alto, CA (US)

(72) Inventors: Hezheng YIN, Beijing (CN); Jinglei REN, Beijing (CN)

(73) Assignee: MERICO, INC., Palo Alto, CA (US)

(21) Appl. No.: 18/239,897

(22) Filed: Aug. 30, 2023

(30) Foreign Application Priority Data
Aug. 30, 2022 (CN) 202211046559.9

(51) Int. Cl. G06F 8/71; G06Q 10/0631

(52) U.S. Cl. CPC G06F 8/71; G06Q 10/063114

(57) ABSTRACT

A method and a device for evaluating workload of programmers are provided. The method includes: acquiring an old version of program code and a new version of program code which is generated by editing the old version of program code by the programmer; parsing the old version of program code into a first syntax tree and parsing the new version of program code into a second syntax tree; generating an edit script including one or more editing operations that cause the first syntax tree to be changed into the second syntax tree; and determining a score for evaluating the workload of the programmer based on the edit script. The method further includes adjusting the score by applying various weights to achieve a more accurate evaluation.

### CROSS-REFERENCE TO RELATED APPLICATIONS

The present application is a U.S. Convention application under 35 U.S.C. § 119 of Chinese Application No. 202211046559.9, filed on Aug. 30, 2022.

### FIELD

The present disclosure relates generally to the field of program development, and in particular to a method and a device for evaluating workload of programmers.

### BACKGROUND

Various organizations, such as companies or open source project organizations, want to accurately measure workload of a programmer who is developing software. However, it is usually difficult to quantify how much work the programmer has actually done. For example, the work of a translator may be measured accurately based on word count, but it is difficult to accurately measure the workload of the programmer based on only the number of lines of code (LOC) or the number of commits (NOC). The term “commit” herein refers to an operation of submitting modified code to a code base after the programmer has modified the code.

In some programming languages such as C/Cpp and Javascript, there is no limit to a length of a line of code. Some programmers may be used to writing longer code in a single line, while others may be used to writing shorter codes in a line. FIG. 1 schematically shows two pieces of code in different formats. The two pieces of code are different in number of lines, and are the same in essential content. Further, some programmers may commit a large amount of changes to existing code in a single commit, while others may modify only a few lines of code for one commit Therefore, it is inaccurate to evaluate workload of a programmer based solely on lines of code or the number of commits.

Therefore, there is a need for a solution for accurately evaluating the workload of the programmers.

### SUMMARY

In view of the above problems, a method and a device capable of accurately evaluating substantive work done by a programmer in developing a program are provided in the present disclosure.

According to an aspect of the disclosure, there is provided a computing device for evaluating workload of a programmer. The device comprises: a memory storing executable instructions, and one or more processors configured to execute the instructions to: acquire an old version of program code and a new version of program code which is generated by editing the old version of program code by the programmer, wherein the old version of program code and the new version of program code are written in a same programming language; parse the old version of program code into a first syntax tree and parse the new version of program code into a second syntax tree; generate an edit script including one or more editing operations that cause the first syntax tree to be changed into the second syntax tree; and determine a score for evaluating the workload of the programmer based on the edit script.

According to another aspect of the present disclosure, a computer-implemented method for evaluating workload of a programmer is provided. The method comprises: acquiring an old version of program code and a new version of program code which is generated by editing the old version of program code by the programmer, wherein the old version of program code and the new version of program code are written in a same programming language; parsing the old version of program code into a first syntax tree and parsing the new version of program code into a second syntax tree; generating an edit script including one or more editing operations that cause the first syntax tree to be changed into the second syntax tree; and determining a score for evaluating the workload of the programmer based on the edit script.

According to another aspect of the present disclosure, there is provided a non-transitory computer-readable medium storing a program which, when executed by a computer, causes the computer to operate as the computing device as described above.

### BRIEF DESCRIPTION OF THE DRAWINGS

The accompanying drawings illustrate embodiments according to the present disclosure and provide a further understanding of the present disclosure. The above and other objects, features and advantages of the present disclosure will be easily understood with reference to the following descriptions of embodiments in conjunction with the drawings. In the drawings:

FIG. 1 schematically shows two pieces of code in different formats;

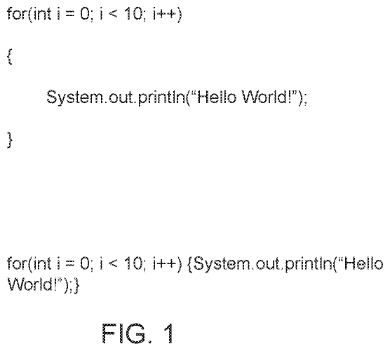

FIG. 2 schematically shows a conceptual diagram of an evaluation method according to the present disclosure;

FIG. 3A shows a simple example of a program for converting nodes in AST of a python program to nodes in UAST;

FIG. 3B schematically shows a definition of a node “class_definition” in AST of the python program, and FIG. 3C shows an exemplary program for converting the node “class_definition” to a node “Class” in UAST;

FIG. 3D shows an exemplary program for converting a node “class_declaration” in AST of a Java program to the node “Class” in UAST;

FIG. 4 schematically shows calculation of scores and weights applied in the calculation;

FIG. 5 is a flowchart showing the evaluation method according to the present disclosure; and

FIG. 6 is a block diagram showing an exemplary configuration of computer hardware for implementing the present disclosure.

### DETAILED DESCRIPTION

Hereinafter, embodiments according to the present disclosure are described in detail with reference to the drawings. In the drawings, the same or similar elements are denoted by the same or similar reference numerals. Further, detailed descriptions of known technologies mentioned in the present disclosure may be omitted if the detailed descriptions would possibly make the subject matter of the present disclosure unclear.

The terminology used herein is for the purpose of describing particular embodiments only, and is not intended to limit the present disclosure. Expressions in singular form also include the plural form unless specified otherwise. Furthermore, the terms “comprising”, “including” and “having” herein are intended to indicate presence of the described features, entities, operations and/or components, rather than exclude the presence or addition of one or more additional features, entities, operations and/or components.

In the following description, specific details are described in order to provide a thorough understanding of the present disclosure. However, the present disclosure may be implemented without some or all of these details. In the drawings, only components that are closely related to the technology of the present disclosure are shown, and other details that are less relevant to the present disclosure are not shown.

Two types of program codes are considered in the present disclosure, one written in a programming language such as C or Java, and the other written in a non-programming language such as JSON or YAML.

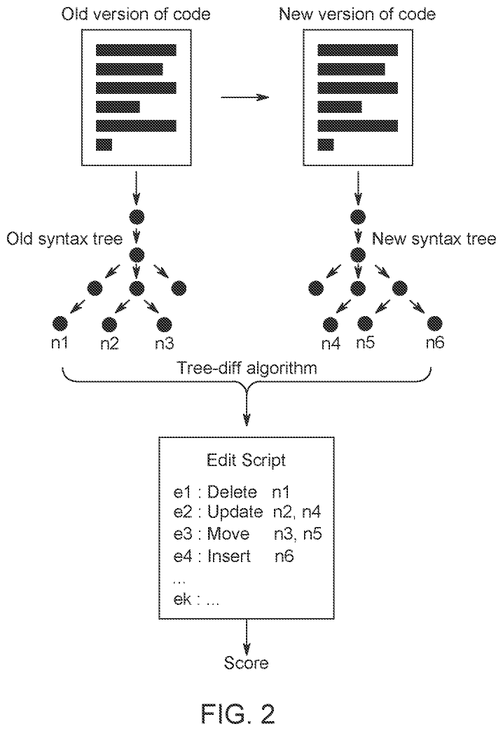

In the following, the technology of the present disclosure will be described first with respect to the program code written in the programming language with reference to FIG. 2.

Since program code is usually stored in a version control system, it is possible to mine the version control system to find the original program code (old version of program code) and new version of the program code submitted by the programmer after editing the original program code. FIG. 2 schematically shows new and old versions of program codes. In the present disclosure, the editing performed by the programmer on the old version of the program code may include addition of code, deletion of code, and modification of code. Regarding a code file newly added by the programmer, it is assumed that an old version corresponding thereto is an empty file. Regarding the old code file canceled by the programmer, it is assumed that a new version corresponding thereto is an empty file.

Then, as shown in FIG. 2, the old version of code and the new version of code are respectively parsed into syntax trees. The syntax tree may include a concrete syntax tree (CST), an abstract syntax tree (AST), and a unified abstract syntax tree (UAST) which will be described below. In the present disclosure, the description is mainly based on the AST and the UAST, but it is apparent for those skilled in the art to use other forms of syntax trees to implement the technology of the present disclosure.

AST is an abstract representation of a grammatical structure of program code, and expresses the grammatical structure of the code in the form of a tree. Each node in the tree represents an element in the code, such as a literal, a variable, an operator, a control flow statement, and so on. Compared to the program code, the AST does not contain inessential punctuations and delimiters, such as braces, semicolons, parentheses, etc. The AST is known to those skilled in the art. In the present disclosure, the existing open source parser may be used to parse the old code and the new code into ASTs respectively.

It should be noted that codes written in different programming languages need to be parsed by different parsers, for example, a parser for parsing Python program code is different from a parser for parsing Java program code. As various programming languages have different grammars and various parsers have different parsing rules, the resulted ASTs may be different from one another in terms of structure of the AST and types of nodes. In order to provide a programming language-independent solution, the AST is preferably converted into a unified abstract syntax tree (UAST) in the present disclosure.

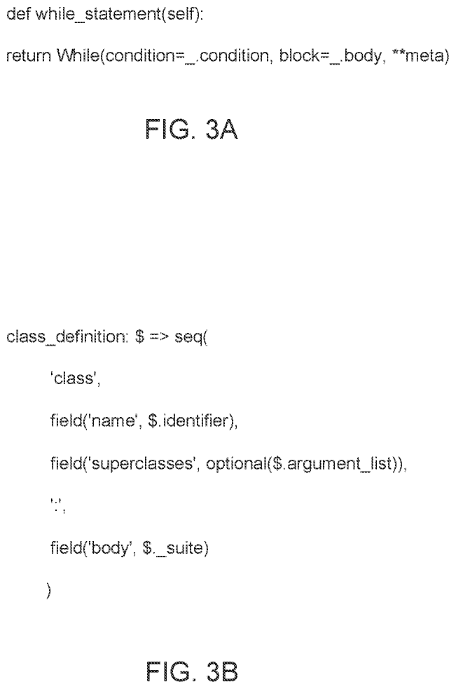

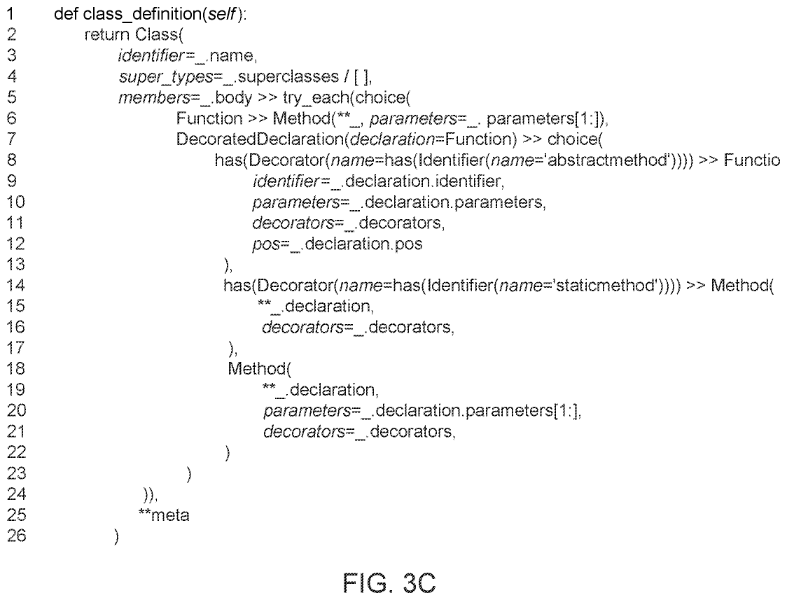

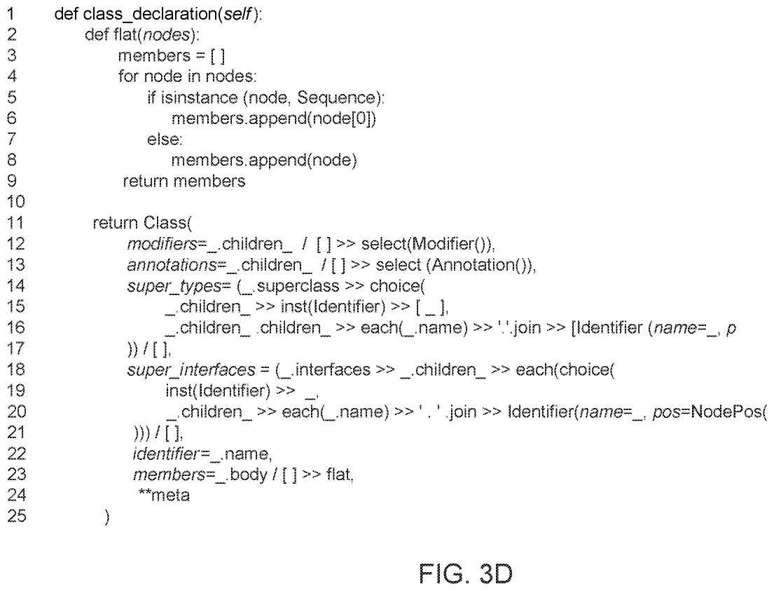

Specifically, based on preset rules, each type of node in the obtained AST is converted into a node defined in accordance to the present disclosure. FIG. 3A shows a program for converting a node “while_statement” in the AST of a python program to a node “While” defined according to the present disclosure, which is a simple conversion example. The fields “condition” and “body” in the node “while_statement” are converted to the fields “condition” and “block” in the node “While”, respectively.

In addition, as a relatively complicated example, FIG. 3B schematically shows a definition of a node “class_definition” in the AST generated by parsing the python program, and FIG. 3C shows an exemplary program for converting the node “class_definition” into a node “Class” defined according to the present disclosure. As shown in FIG. 3B and FIG. 3C, the fields “name”, “superclasses” and “body” in the node “class_definition” are converted into “identifier”, “super_types” and “members” in the node “Class”, respectively.

In addition, FIG. 3D shows an exemplary program for converting a similar node (e.g., “class_declaration”) in the AST corresponding to program code in another language (Java) into the node “Class” defined in accordance to the present disclosure. That is, nodes in different ASTs, which have different definitions and the same or similar substantive meanings, can be converted into the same node defined in the present disclosure. In this way, ASTs generated based on codes in different programming languages can be converted into a unified tree UAST.

In the present disclosure, a conversion rule is preset for each node type in the AST corresponding to each programming language. The programs in FIGS. 3A to 3D provide some examples of conversion rules. Obviously, it is unrealistic to enumerate all the rules here, and those skilled in the art may design appropriate conversion rules depending on actual design requirements.

The UAST according to the present disclosure may represent common elements between different programming languages, such as class, method declaration, literal, control flow, operator, etc. Further, the UAST is independent of the type of programming language.

Referring back to FIG. 2, after generating the old syntax tree (preferably, old UAST) corresponding to the old version of the code and the new syntax tree (preferably, new UAST) corresponding to the new version of the code, differences between the new and old syntax trees are determined through a tree-diff algorithm, for example, GumTree algorithm. The GumTree algorithm is described in “Fine-grained and Accurate Source Code Differencing”, Jean-Remy Falleri et al., Proceedings of the International Conference on Automated Software Engineering, Vasteras, Sweden, 2014, pp. 313-324. The content of this article is incorporated herein by reference. However, those skilled in the art may use other appropriate algorithms to calculate the differences, which is not limited in the present disclosure.

A data structure called “edit script” is then generated based on the determined differences between the old syntax tree and the new syntax tree. As shown in FIG. 2, the edit script describes a series of editing operations performed on the nodes of the syntax tree, which operations change the old syntax tree into the new syntax tree. The edit script aims to accurately reflect the changes made to the old syntax tree, and thus reflect the substantive changes made by the programmer to the old version of the code.

For example, the edit script may include the following editing operations:
Insert: adding a node,
Delete: removing a node,
Update: replacing an old value of a node with a new value, and
Move: move a node under a different parent node. In particular, as the node is moved, all children of the node are moved as well, and therefore this operation moves a whole sub-tree.

In the example of the edit script shown in FIG. 2, a node n1 in the old syntax tree is deleted (operation e1). The value of a node n2 in the old syntax tree is updated and the node n2 becomes a node n4 in the new syntax tree (operation e2). A node n3 in the old syntax tree is moved and becomes a node n5 in the new syntax tree (operation e3). A node n6 is inserted in the new syntax tree (operation e4). It should be understood that the edit script may include multiple editing operations of the same type (for example, 3 delete operations for 3 nodes), or may not include one or more of the above editing operations (for example, no insert operation).

As mentioned above, the edit script reflects substantive changes made to the older version of the code. It is therefore possible to evaluate how much work a programmer has done in writing the new codes, based on the edit script. As a simple evaluation method, a score may be determined based on the number of editing operations contained in the edit script. For example, the edit script shown in FIG. 2 includes four editing operations (e1, e2, e3, e4), and therefore the score may be determined to be 4.

Furthermore, there may be a case where the new version of the code is program code created by a programmer, that is, there is no old version of code. The evaluation method shown in FIG. 2 may still be applied in this case. Specifically, the old version of the code may be assumed to be an empty code, accordingly the old syntax tree may be assumed to be an empty syntax tree. An edit script is then generated based on differences between the old syntax tree (empty syntax tree) and the new syntax tree. In effect the edit script is generated based on the new syntax tree, and a score is then calculated based on the edited script. Therefore, the present disclosure does not have to obtain both old and new versions of program codes to evaluate the workload of the programmer, but is also applicable to evaluate the workload of the programmer on the basis of a single program code.

The workload of the programmer may be measured based on the determined score. The higher the score is, the more substantive changes have been made to the older version of the code by the programmer, and the greater the workload is. In practice, software companies or open source project organizations may provide remuneration or other forms of rewards to the programmer based on this score.

Further, since the entire code file is usually very large, the syntax tree generated based on the code file is also large, thus consuming a large amount of computing resources in the calculation. Therefore, preferably, the process shown in FIG. 2 is executed on the basis of code segments in the present disclosure. An example of the code segment is a function, because the function is a common part of the code file, and the smallest unit of code change is usually a function. Hereinafter, description is made based on functions. However, code segments in the present disclosure are not limited to functions, and those skilled in the art may use other forms of code segments.

To be specific, a function is extracted from the old version of the code (hereinafter referred to as “old function”), and a function is extracted from the new version of the code (hereinafter referred to as “new function”). The new version of the code is obtained by editing the old version of the code by the programmer. Then, it is determined whether the old function and the new function correspond to the same function. The old and new functions are considered to match each other if they are determined to be different versions of the same function before and after editing. In particular, regarding a newly added function, it is assumed that an old function that matches the new function is an empty function. Regarding a canceled old function, it is assumed that a new function that matches the old function is an empty function. As such, one or more pairs of functions representing the changes between the old and new versions of codes can be obtained.

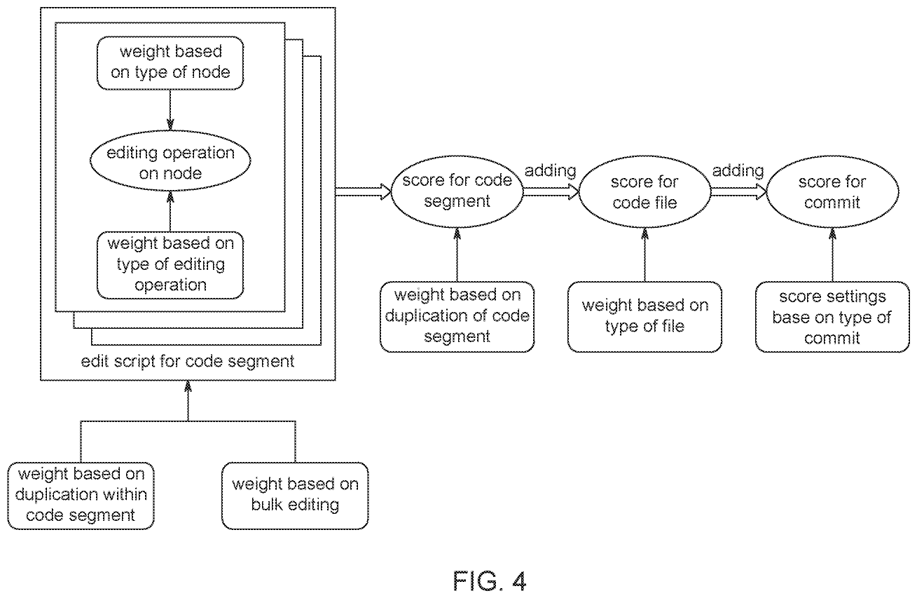

An old syntax tree and a new syntax tree may be constructed for a pair of old function and new function that match each other according to the process shown in FIG. 2. A tree-diff algorithm is then applied to generate the edit script, and a score for the function is calculated based on the edit script. This score reflects the substantive modifications the programmer made when modifying the old function. In this way, scores are calculated for all pairs of functions that match each other in the old and new code files, and then the obtained scores for the functions are added to generate a score for the code file. Further, scores may be calculated for a number of code files committed by the programmer at one time, and then the obtained scores for the code files are added to generate a score for one commit FIG. 4 schematically shows calculations of the score for a function, the score for a code file and the score for a commit. It is possible to evaluate the amount of work of the programmer in modifying a function, a code file, or multiple code files in one commit, based on the calculated score.

A simple evaluation method for determining a score based on the number of editing operations included in an edit script is described above. To further improve accuracy of the evaluation, mechanisms for adjusting the scores based on additional factors are provided according to the present disclosure. Specifically, the present disclosure adjusts the scores mainly based on the following mechanisms:
weighting based on a type of an editing operation,
weighting based on a type of a node,
weighting based on duplication within a code segment,
weighting based on bulk editing,
weighting based on duplication of a code segment,
weighting based on a type of a file, and
score settings based on a type of a commit.

The above adjustment mechanisms will be described in conjunction with FIG. 4. However, it should be noted that in the present disclosure, the score may also be adjusted based on a depth, a width or other complexity statistics of a syntax tree, or based on a position of a node in the syntax tree or other additional information.

[Weighting Based on a Type of Editing Operation]

As mentioned above, the editing operation may include insert, delete, update, and move. A weight is set for each type of editing operation according to an amount of work corresponding to the type of editing operation in the present disclosure. For example, the insert operation that creates new contents may be given a larger weight, and the relatively simple delete operation may be given a smaller weight. Those skilled in the art can set weights for various editing operations in an appropriate manner based on experiments or investigation of actual situations.

FIG. 4 schematically illustrates application of weights based on the type of editing operation in the process of calculating a score for a code segment (e.g., a function). Referring to the example shown in FIG. 2 again, if a delete operation is given a weight of 0.4, an update operation is given a weight of 0.7, a move operation is given a weight of 0.8, and an insert operation is given a weight of 1, then the score calculated based on the editing operations e1 to e4 is: 0.4+0.7+0.8+1=2.9.

More generally, a score S for a code segment may be calculated based on the following formula (1).

$$S = {\sum }_{e} {W}_{edit\_type} \qquad ( 1 )$$

In formula (1), e represents an editing operation, and W_{edit_type} represents a weight based on a type of the editing operation.

[Weighting Based on a Type of Node]

Each node in the syntax tree has a type, to indicate that the node represents a variable name, a literal, an operator, or a more complex coding construct (such as loop), etc. Therefore, a weight is set for each node type in the present disclosure. As an example, a variable name and an operator (such as “<=”) each may be given a weight of “1”, and a literal (such as “6.0” or “0”) may be given a lower weight, e.g., “0.1”. Additionally, a larger weight, such as “2”, may be set for an IF statement, a class, or other complex construct.

FIG. 4 schematically illustrates application of weights based on the type of node in calculating a score for a code segment. Referring to the example shown in FIG. 2 again, it is assumed that a weight of 0.4 is set for the delete operation, a weight of 0.7 is set for the update operation, a weight of 0.8 is set for the move operation, and a weight of 1 is set for the insert operation. Further, weights of 0.3, 0.5, 1, and 0.9 are set for nodes n1, n2, n3, and n6 respectively, based on the type of the node. The calculated score in this case is: 0.4×0.3+0.7×0.5+0.8×1+1×0.9=2.17.

More generally, a score S for a code segment may be calculated based on the following formula (2).

$$S = {\sum }_{e} {W}_{{edit}_{type}} \cdot {W}_{{node}_{type}} \qquad ( 2 )$$

In formula (2), W_{node_type} represents a weight based on a type of a node to which an editing operation is applied.

[Weighting Based on Duplication within a Code Segment]

Code duplication occurs when a programmer has to add a series of similar operations. Copying code may be an appropriate way to handle some situations, but a programmer should not be rewarded for dozens of nodes added this way. Therefore, the insert operation by duplicating code is checked in the present disclosure, and the score for such operation is reduced.

Sometimes a syntax tree generated by parsing a code file may be very large, and a clone detection algorithm may thus be performed on a subtree of the syntax tree to detect duplicate code within a code segment (e.g., a function). A clone detection algorithm is described in “Clone Detection Using Abstract Syntax Trees” by Ira D. Baxter et al. and “Tree-Pattern-based Duplicate Code Detection” by Hyo-Sub Lee et al. Duplicate codes as well as similar codes (e.g., codes with a similarity greater than a certain threshold) can be found by ignoring values of leaves of the UAST.

Then, weights may be set for nodes in the syntax tree corresponding to the repeated/similar codes based on similarity and the number of duplications. Generally, the more repetitions, the smaller the weight set for the node corresponding to the repeated code. The greater the similarity, the smaller the weight set for the node corresponding to similar codes. In addition, in the present disclosure, if the number of nodes included in the detected same or similar codes is less than a preset threshold, the nodes in the same or similar codes may not be assigned with weights.

FIG. 4 schematically illustrates application of weights based on duplication within a code segment in the process of calculating a score for a code segment. A score S for the code segment may be calculated based on the following formula (3).

$$S = {\sum }_{e} {W}_{edit\_type} \cdot {W}_{node\_type} \cdot {W}_{intra\_function} \qquad ( 3 )$$

In formula (3), W intra function represents a weight applied to a node based on duplication within the code segment.

[Weighting Based on Bulk Editing]

The programmer sometimes makes the same changes to one or more code files at a time, for example, renaming a variable name or a class name, replacing one function with another, adding the same code in multiple lines, and so on. There are many ways to perform bulk editing, and the most common way is using “Find and Replace” tool in an editor or using an integrated development environment (IDE) refactoring tool. Since most of the work is done by the editor or IDE, the programmer should not be rewarded for the bulk editing.

A text-based algorithm is used in the present disclosure to detect bulk editing in a number of code files submitted in one commit Specifically, an “edit pattern” for an editing operation is represented by a pair of old text pattern and new text pattern. The edit pattern indicates mode and characteristics of the editing operation, and each editing operation has its own unique edit pattern. An edit pattern is identified for a change in each line in each code file committed by the programmer, and the number of occurrences of each edit pattern is counted. If the number of occurrences of a certain edit pattern is greater than a preset threshold, said edit pattern is determined to be “bulk editing”.

After the bulk editing is detected, a weight may be set based on the number of occurrences of the editing pattern, and the weight may be set to nodes in the syntax tree corresponding to a code that has been changed due to the editing operation identified as the bulk editing. Generally, the more occurrences of an editing pattern, the smaller the weight set to the corresponding nodes in the syntax tree.

FIG. 4 schematically illustrates application of weights based on bulk editing in calculating a score for a code segment. To be specific, the score S for the code segment may be calculated based on the following formula (4).

$$S = {\sum }_{e} {W}_{edit\_type} \cdot {W}_{node\_type} \cdot {W}_{intra\_function} \cdot {W}_{bulk\_editing} \qquad ( 4 )$$

In formula (4), W_{bulk_editing} represents a weight applied to a node based on bulk editing.

The calculation of the score for the code segment has been described above through formulas (1) to (4). However, it should be noted that the present disclosure is not limited thereto, and the score may be calculated based on the weights in a different manner. For example, each weight in formulas (1) to (4) may be replaced with the n-th power of the weight. Those skilled in the art may design a suitable method of calculation according to actual situation.

[Weighting Based on Duplication of a Code Segment]

Programmers often acquire code, even an entire function, from other parts of a project or from free open source projects available on the Internet, and copy the acquired function into the program currently being developed. Obviously the programmer should not be rewarded for such copying operation. Therefore, in the present disclosure, it is checked whether a code segment (e.g., a function) committed by a programmer is a duplicate of an existing code segment (e.g., a function) in a code base owned by the organization or in another code base (e.g., an open source project).

Duplicate function may be detected based on a similarity between syntax tree corresponding to the committed function and syntax tree corresponding to the existing function. Considering that creating syntax trees for all codes stored in various code bases requires a huge amount of work, it is also possible to detect duplicate function based on the code itself. That is, the duplicate function may be detected based on a text similarity between functions.

Regarding each newly added function committed by the programmer, if it is determined to be the same or similar to a known function stored in the code base (for example, a similarity between the new function and the known function is greater than a threshold), a weight is determined based on the similarity between the newly added function and the known function, and is set to the newly added function. As an example, the weight w may be set as w=1−S, where S represents the similarity.

FIG. 4 schematically illustrates application of weights based on duplication of a code segment in the process of calculating a score for a code file. Specifically, in the process of adding the scores for respective code segments to obtain the score for the code file, the score for the newly added code segment is multiplied by the weight as described above, and then the weighted score is added to the scores of other code segments in order to obtain the score for the code file.

[Weighting Based on a Type of File]

In a project, not all code files are created by developers manually. For example, some files are automatically generated by a development tool. Further, not all types of code files are written with the same effort. For example, a Java POJO file looks like a normal class, but it is much easier to write the Java POJO file (manually or using a template). In the present disclosure, the score for an automatically generated file is directly set to “0” because the automatically generated file is not written by a programmer. In addition, for a specific type of code file (such as Java POJO file), a smaller weight may be set to the file. Those skilled in the art may decide which types of code files may be assigned with small weights according to investigation of the actual situation.

FIG. 4 schematically illustrates application of weights based on a type of file in the process of calculating a score for a commit. To be specific, a score for each file is multiplied by a weight as described above, and then the weighted scores are added to obtain the score for the commit

[Score Settings Based on a Type of Commit]

Following types of commit are defined in the present disclosure according to characteristics of codes committed by programmers, and a score is set for each type of commit
Revert. This type may be a revert commit in Git for example. Git is a distributed version control system. Since the commit is created by a Git operation without effort of the programmer, a score for such commit is set to “0” in the present disclosure.
Cherry-pick. This type may be a cherry-pick commit in Git for example. Since this commit is also created by a Git operation, a score for such commit is set to “0” in the present disclosure.
Merge. This type may be a merge commit in Git for example. Since this commit is also created by a Git operation, a score for such commit is set to “0” in the present disclosure.
Modified Cherry-pick. This type is a commit created by making small modifications on the basis of Cherry-pick in Git. In the present disclosure, a score for such commit is reduced according to a similarity between this commit and the Cherry-pick commit in Git.
Large Insertion. This type is a commit in which a huge amount of code is added. As the large amount of added code is usually copied from other sources, this type of commit is deemed to be an unusual commit, and the score for the unusual commit is set to “0” in the present disclosure. As an example, when the number of lines of the added code exceeds a predetermined threshold (e.g., 10,000 lines), the commit may be considered unusual.
Large Deletion. This type is a commit in which a huge amount of code is deleted. This type of commit is considered to be an unusual commit and its score is set to “0” in the present disclosure. As an example, when the number of lines of the deleted code exceeds a predetermined threshold (e.g., 10,000 lines), the commit may be considered unusual.

In addition to the above, it is possible in the present disclosure to manually set a certain type of commit on a blacklist, and a score of the blacklisted commit is set to “0”. It is easy to understand that those skilled in the art can create a blacklist according to actual requirements.

FIG. 4 schematically illustrates setting a score according to a type of a commit when calculating the score for the commit.

It should be noted that those skilled in the art may selectively use one or more of the weights provided in the present disclosure according to actual design requirements.

Technology of the present disclosure has been described with respect to codes written in a programming language, in which differences between the old syntax tree and the new syntax tree are utilized. On the other hand, for program codes written in non-programming languages (such as JSON, YAML, XML, HTML, Markdown, Makefile, etc.), since it is impossible to build a syntax tree from the program code, workload of the programmer is evaluated based on the number of lines of code (LOC). Nevertheless, unlike the conventional method using only the number of lines of code, in the present disclosure different weights may be set in advance for various non-programming languages according to how difficult it is to write a program in each of the non-programming languages. Then the number of lines of the code that has been changed is multiplied by the weight, and the resulted value is used to assess the workload of the programmer. In addition, it is also determined in the present disclosure whether the changed code is “added” or “deleted”, and a greater weight may be applied to the number of lines of the added code than the number of lines of the deleted code. In this way, the present disclosure also provides a method for more accurately evaluating the workload of the programmer with respect to codes in non-programming languages.

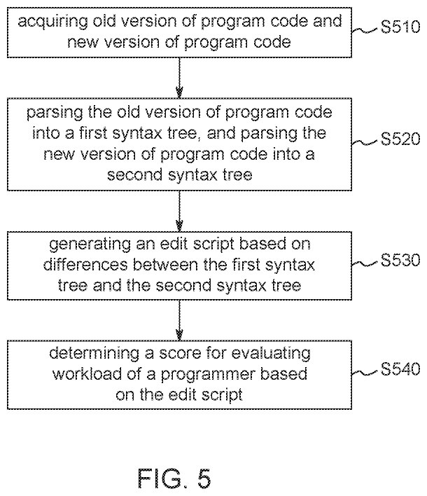

A flowchart of the evaluation method according to the present disclosure will be described below with reference to FIG. 5.

As shown in FIG. 5, in step S510, an old version of program code and a new version of program code are acquired. The new version of program code is generated by editing the old version of program cod by a programmer.

In step S520, the old version of program code is parsed into a first syntax tree, and the new version of program code is parsed into a second syntax tree.

In step S530, an edit script is generated based on differences between the first syntax tree and the second syntax tree. The edit script includes one or more editing operations that cause the first syntax tree to be changed into the second syntax tree.

In step S540, a score for evaluating workload of the programmer is determined based on the edit script. The score may be determined based on the number of editing operations included in the edit script. Preferably, the score is calculated based on the editing operations and one or more weights described above to achieve a more accurate assessment.

The method described in the above embodiments may be implemented by software, hardware, or a combination of software and hardware. Programs included in the software may be stored in advance in a storage medium provided inside or outside a device. As one example, these programs, when being executed, are written in a random-access memory (RAM) and executed by a processor (e.g., CPU), thereby implementing various processes described herein.

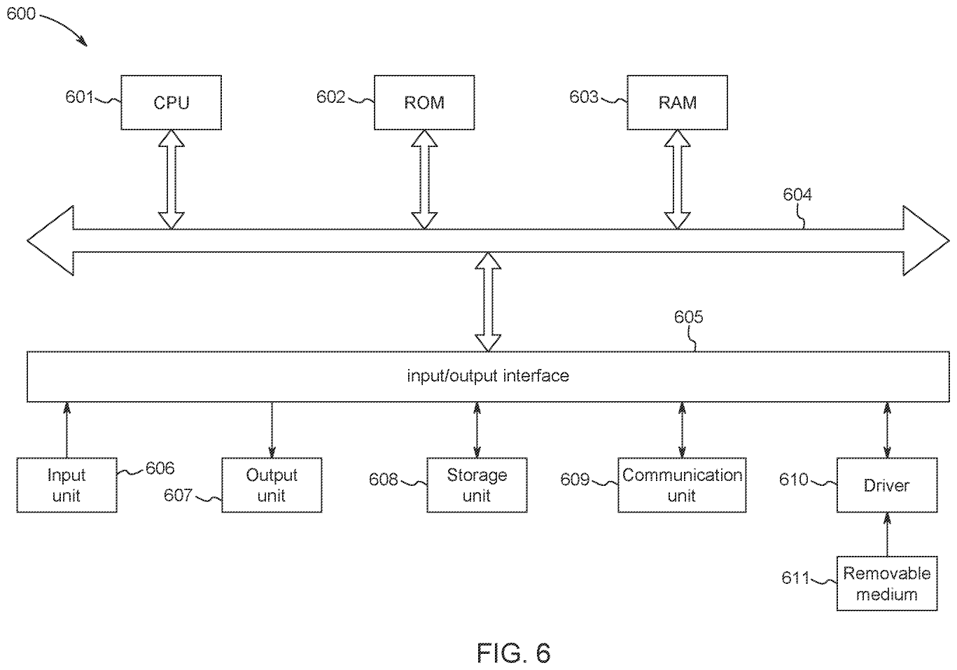

FIG. 6 is a block diagram showing an example configuration of computer hardware that implements the method of the present disclosure according to a program. The computer hardware is an example of a computing device for evaluating workload of a programmer according to the present disclosure.

As shown in FIG. 6, in a computer 600, a central processing unit (CPU) 601, a read only memory (ROM) 602, and a random-access memory (RAM) 603 are connected to each other via a bus 604.

An input/output interface 605 is also connected to the bus 604. The input/output interface 605 is connected to the following components: an input unit 606 formed with keyboard, mouse, microphone and the like; an output unit 607 formed with display, speaker and the like; a storage unit 608 formed with hard disk, non-volatile memory and the like; a communication unit 609 formed by a network interface card (such as local area network (LAN) card, and modem); and a driver 610 for driving a removable medium 611. The removable medium 611 is for example a magnetic disk, an optical disk, a magneto-optical disk, or a semiconductor memory.

In the computer with the above-stated structure, the CPU 601 loads the program stored in the storage unit 608 into the RAM 603 via the input/output interface 605 and the bus 604, and executes the program to perform the method described in the present invention.

A program to be executed by the computer (CPU 601) may be recorded on a removable medium 611 which may be a package medium. The package medium is formed with for example a magnetic disk (including floppy disk), an optical disk (including compact disk-read only memory (CD-ROM)), digital versatile disk (DVD), or the like), a magneto-optical disk, or a semiconductor memory. In addition, the program to be executed by the computer (CPU 601) may also be provided via a wired or wireless transmission medium such as local area network, Internet, or digital satellite broadcasting.

When the removable medium 611 is installed in the drive 610, the program may be installed in the storage unit 608 via the input/output interface 605. In addition, the program may be received by the communication unit 609 via a wired or wireless transmission medium, and installed in the storage unit 608. Alternatively, the program may be installed in the ROM 602 or the storage unit 608 in advance.

The program to be executed by the computer may be a program that performs processes in the order described in the present disclosure, or may be a program that performs processes in parallel or when necessary (e.g., when invoked).

The units or devices described herein are only in logical sense, and do not strictly correspond to physical devices or entities. For example, the function of each unit described herein may be implemented by multiple physical entities. Alternatively, functions of several units described herein may be implemented by a single physical entity. In addition, features, components, elements, steps or the like described in one embodiment are not limited to the embodiment, but may also be applied in other embodiments to for example replace or combine with specific features, components, elements, steps or the like in other embodiments.

The scope of the present disclosure is not limited to the embodiments described herein. Those skilled in the art should understand that, depending on design requirements and other factors, various modifications or changes may be made to the embodiments herein without departing from principle of the present invention. The scope of the invention is defined by the appended claims and their equivalents.

In addition, the present disclosure may include the following implementations.

(1) A computing device for evaluating workload of a programmer, comprising:
a memory storing executable instructions; and
one or more processors configured to execute the instructions to:
   acquire an old version of program code and a new version of program code which is generated by editing the old version of program code by the programmer, wherein the old version of program code and the new version of program code are written in a same programming language;
   parse the old version of program code into a first syntax tree, and parse the new version of program code into a second syntax tree;
   generate an edit script including one or more editing operations that cause the first syntax tree to be changed into the second syntax tree; and
   determine a score for evaluating the workload of the programmer based on the edit script.

(2). The computing device according to (1), wherein the processor is further configured to acquire the old version of program code and the new version of program code by mining a version control system.

(3). The computing device according to (1), wherein
the first syntax tree is a first abstract syntax tree (AST), and the second syntax tree is a second AST; and
tree structures and node types of the first AST and the second AST vary with a change of the programming language.

(4). The computing device according to (3), wherein the processor is further configured to convert the first AST and the second AST into a first unified abstract syntax tree (UAST) and a second UAST respectively based on preset rules, and wherein tree structures and node types of the first UAST and the second UAST do not change with a change of the programming language.

(5). The computing device according to (1), wherein the processor is further configured to determine differences between the first syntax tree and the second syntax tree, and generate the edit script based on the differences.

(6). The computing device according to (1), wherein the processor is further configured to determine the score based on the number of the editing operations included in the edit script.

(7). The computing device according to (1), wherein the editing operations included in the edit script comprise at least one of an insertion operation for adding a node, a deletion operation for deleting a node, an update operation for replacing an old value of a node with a new value, and a move operation for moving a node under a different parent node.

(8). The computing device according to (7), wherein in a case where the old version of program code and the new version of program code each correspond to a single code segment, the determined score is for evaluating the workload of editing the single code segment by the programmer.

(9). The computing device according to (8), wherein the processor is further configured to determine the score for the single code segment based on the editing operations included in the edit script and at least one of a weight based on a type of editing operation, a weight based on a type of node, a weight based on duplicate code within the single code segment, and a weight based on bulk editing.

(10). The computing device according to (8), wherein in a case where the old version of program code and the new version of program code each correspond to a single code file which comprises a plurality of code segments, the processor is further configured to add the scores determined for the plurality of code segments to obtain a score for evaluating the workload of editing the single code file by the programmer.

(11). The computing device according to (10), wherein the processor is further configured to detect whether a code segment newly added in the new version of program code is same or similar as a known code segment, and apply a weight based on a similarity to a score determined for the newly added code segment, to calculate the score for the single code file.

(12). The computing device according to (10), wherein in a case where the old version of program code and the new version of program code each correspond to a plurality of code files committed by the programmer at one time, the processor is further configured to add the scores determined for the plurality of code files, to obtain a score for evaluating the workload of editing the plurality of code files by the programmer.

(13). The computing device according to (12), wherein the processor is further configured to apply a weight based on a type of the code file to a score determined for the corresponding code file, to calculate the score for the plurality of code files.

(14). The computing device according to (12), wherein the processor is further configured to set the score for the plurality of code files based on a type of a commit made by the programmer.

(15). The computing device according to (1), wherein in a case where the old version of program code and the new version of program code are written in a same non-programming language, the processor is configured to determine the number of lines of code that are changed in the new version of program code compared with the old version of program code, and to evaluate the workload of the programmer based on the determined number of lines of the changed code.

(16). The computing device according to (15), wherein the processor is further configured to multiply the determined number of lines of the changed code by a weight, and evaluate the workload of the programmer based on the weighted number of lines, and wherein the weight is based on at least one of a degree of difficulty in writing the program code in the non-programming language, and a manner in which the changed code has been changed.

(17). The computing device according to (1), wherein in a case where the new version of program code is newly created by the programmer, the processor is further configured to: set the old version of program code to be empty, set the first syntax tree to be empty, generate the edit script based on differences between the empty syntax tree and the second syntax tree, and determine a score for evaluating the workload of creating the new version of program code by the programmer based on the edit script.

(18) A computer-implemented method for evaluating workload of a programmer, comprising:
acquiring an old version of program code and a new version of program code which is generated by editing the old version of program code by the programmer, wherein the old version of program code and the new version of program code are written in a same programming language;
parsing the old version of program code into a first syntax tree, and parsing the new version of program code into a second syntax tree;
generating an edit script including one or more editing operations that cause the first syntax tree to be changed into the second syntax tree; and
determining a score for evaluating the workload of the programmer based on the edit script.

(19). The method according to (18), further comprising:
acquiring the old version of program code and the new version of program code by mining a version control system.

(20). The method according to (18), wherein
the first syntax tree is a first abstract syntax tree (AST), the second syntax tree is a second AST; and
tree structures and node types of the first AST and the second AST vary with a change of the programming language.

(21). The method according to (20), further comprising:
converting the first AST and the second AST into a first unified abstract syntax tree (UAST) and a second UAST respectively based on preset rules, and wherein tree structures and node types of the first UAST and the second UAST do not change with a change of the programming language.

(22). The method according to (18), further comprising:
determining differences between the first syntax tree and the second syntax tree, and generating the edit script based on the differences.

(23). The method according to (18), further comprising:
determining the score based on the number of the editing operations included in the edit script.

(24). The method according to (18), wherein the editing operations included in the edit script comprises at least one of an insertion operation for adding a node, a deletion operation for deleting a node, an update operation for replacing an old value of a node with a new value, and a move operation for moving a node under a different parent node.

(25). The method according to (24), wherein in a case where the old version of program code and the new version of program code each correspond to a single code segment, the determined score is for evaluating the workload of editing the single code segment by the programmer.

(26). The method according to (25), further comprising:
determining the score for the single code segment based on the editing operations included in the edit script and at least one of a weight based on a type of editing operation, a weight based on a type of node, a weight based on duplicate code within the single code segment, and a weight based on bulk editing.

(27). The method according to (25), further comprising:
in a case where the old version of program code and the new version of program code each correspond to a single code file which comprises a plurality of code segments, adding the scores determined for the plurality of code segments, to obtain a score for evaluating the workload of editing the single code file by the programmer.

(28). The method according to (27), further comprising:
detecting whether a code segment newly added in the new version of program code is same or similar as a known code segment, and applying a weight based on a similarity to a score determined for the newly added code segment, to calculate the score for the single code file.

(29). The method according to (27), further comprising:
in a case where the old version of program code and the new version of program code each correspond to a plurality of code files committed by the programmer at one time, adding the scores determined for the plurality of code files, to obtain a score for evaluating the workload of editing the plurality of code files by the programmer.

(30). The method according to (29), further comprising:
applying a weight based on a type of the code file to a score determined for the corresponding code file, to calculate the score for the plurality of code files.

(31). The method according to (29), further comprising:
setting the score for the plurality of code files based on a type of a commit made by the programmer.

(32). The method according to (18), further comprising:
in a case where the old version of program code and the new version of program code are written in a same non-programming language, determining the number of lines of code that are changed in the new version of program code compared with the old version of program code, and evaluating the workload of the programmer based on the determined number of lines of the changed code.

(33). The method according to (32), further comprising:
multiplying the determined number of lines of the changed code by a weight, and evaluating the workload of the programmer based on the weighted number of lines, wherein the weight is based on at least one of a degree of difficulty in writing the program code in the non-programming language, and a manner in which the changed code has been changed.

(34). The method according to (18), further comprising:
in a case where the new version of program code is newly created by the programmer, setting the old version of program code to be empty, setting the first syntax tree to be empty, generating the edit script based on differences between the empty syntax tree and the second syntax tree, and determining a score for evaluating the workload of creating the new version of program code by the programmer based on the edit script.

(35). A non-transitory computer-readable medium storing a program that, when executed by a computer, causes the computer to operate as the computing device according to any one of (1) to (17).

1. A computing device to evaluate workload of a programmer, the computing device comprising:
a memory storing executable instructions; and
one or more processors configured to execute the instructions to:
acquire an old version of program code and a new version of program code which is generated by editing the old version of program code by the programmer, wherein the old version of program code and the new version of program code are written in a same programming language;
parse the old version of program code into a first syntax tree, and parse the new version of program cde into a second syntax tree;
generate an edit script including one or more editing operations that cause the first syntax tree to be changed into the second syntax tree; and
determine a score for evaluating the workload of the programmer based on the edit script.

2. The computing device of claim 1, wherein the one or more processors are further configured to acquire the old version of program code and the new version of program code by mining a version control system.

3. The computing device of claim 1, wherein:
the first syntax tree is a first abstract syntax tree (AST), and the second syntax tree is a second AST; and
tree structures and node types of the first AST and the second AST vary with a change of the programming language.

4. The computing device of claim 3, wherein the one or more processors are further configured to convert the first AST and the second AST into a first unified abstract syntax tree (UAST) and a second UAST respectively based on preset rules, and wherein tree structures and node types of the first UAST and the second UAST do not change with a change of the programming language.

5. The computing device of claim 1, wherein the one or more processors are further configured to determine differences between the first syntax tree and the second syntax tree, and generate the edit script based on the differences.

6. The computing device of claim 1, wherein the one or more processors are further configured to determine the score based on the number of the editing operations included in the edit script.

7. The computing device of claim 1, wherein the editing operations included in the edit script comprise at least one of:
an insertion operation for adding a node,
a deletion operation for deleting a node,
an update operation for replacing an old value of a node with a new value, and
a move operation for moving a node under a different parent node.

8. The computing device of claim 7, wherein in a case where the old version of program code and the new version of program code each correspond to a single code segment, the determined score is for evaluating the workload of editing the single code segment by the programmer.

9. The computing device of claim 8, wherein the one or more processors are further configured to determine the score for the single code segment based on the editing operations included in the edit script and at least one of:
a weight based on a type of editing operation,
a weight based on a type of node,
a weight based on duplicate code within the single code segment, and
a weight based on bulk editing.

10. The computing device of claim 8, wherein in a case where the old version of program code and the new version of program code each correspond to a single code file which comprises a plurality of code segments, the one or more processors are further configured to add the scores determined for the plurality of code segments, to obtain a score for evaluating the workload of editing the single code file by the programmer.

11. The computing device of claim 10, wherein the one or more processors are further configured to detect whether a code segment newly added in the new version of program code is same or similar as a known code segment, and apply a weight based on a similarity to a score determined for the newly added code segment, to calculate the score for the single code file.

12. The computing device of claim 10, wherein in a case where the old version of program code and the new version of program code each correspond to a plurality of code files committed by the programmer at one time, the one or more processors are further configured to add the scores determined for the plurality of code files, to obtain a score for evaluating the workload of editing the plurality of code files by the programmer.

13. The computing device of claim 12, wherein the one or more processors are further configured to apply a weight based on a type of the code file to a score determined for the corresponding code file, to calculate the score for the plurality of code files.

14. The computing device of claim 12, wherein the one or more processors are further configured to set the score for the plurality of code files based on a type of a commit made by the programmer.

15. The computing device of claim 1, wherein in a case where the old version of program code and the new version of program code are written in a same non-programming language, the one or more processors are configured to determine the number of lines of code that are changed in the new version of program code compared with the old version of program code, and to evaluate the workload of the programmer based on the determined number of lines of the changed code.

16. The computing device of claim 15, wherein:
the one or more processors are further configured to multiply the determined number of lines of the changed code by a weight, and evaluate the workload of the programmer based on the weighted number of lines, and
the weight is based on at least one of a degree of difficulty in writing the program code in the non-programming language, and a manner in which the changed code has been changed.

17. The computing device of claim 1, wherein in a case where the new version of program code is newly created by the programmer, the one or more processors are further configured to:
set the old version of program code to be empty;
set the first syntax tree to be empty;
generate the edit script based on differences between the empty syntax tree and the second syntax tree; and
determine a score for evaluating the workload of creating the new version of program code by the programmer based on the edit script.

18. A computer-implemented method for evaluating workload of a programmer, the method comprising:
acquiring an old version of program code and a new version of program code which is generated by editing the old version of program code by the programmer, wherein the old version of program code and the new version of program code are written in a same programming language;
parsing the old version of program code into a first syntax tree, and parsing the new version of program code into a second syntax tree;
generating an edit script including one or more editing operations that cause the first syntax tree to be changed into the second syntax tree; and
determining a score for evaluating the workload of the programmer based on the edit script.

19. The method of claim 18, further comprising:
determining differences between the first syntax tree and the second syntax tree, and generating the edit script based on the differences.

20. The method of claim 18, further comprising:
determining the score based on the editing operations included in the edit script and at least one of:
a weight based on a type of an editing operation,
a weight based on a type of a node in the first syntax tree and the second syntax tree,
a weight based on duplication or similarity of program code,
a weight based on bulk editing,
a weight based on a type of a code file, and
score settings based on a type of a commit made by the programmer.

21. A non-transitory computer readable medium storing a program which, when executed by a computer, causes the computer to operate as the computing device of claim 1.
